(19) United States
(12) Patent Application Publication
(10) Pub. No.: US 2026/0157336 A1
(43) Pub. Date: Jun. 11, 2026

(54) CAT LITTER BOX AND ANTI-PINCH STRUCTURE THEREOF

(71) Applicant: SHENZHEN PETABOO TECHNOLOGY CO., LTD., SHENZHEN (CN)

(72) Inventor: BOCHAO XU, SHENZHEN (CN)

(21) Appl. No.: 19/408,664

(22) Filed: Dec. 4, 2025

(30) Foreign Application Priority Data
Dec. 6, 2024 (CN) 202423015579.7

(51) Int. Cl. A01K 1/01

(52) U.S. Cl. CPC A01K 1/0107

(57) ABSTRACT

A cat litter box and an anti-pinch structure thereof are provided. The anti-pinch structure includes a base, a cat litter bin, and limiting structures. Central shafts are disposed on two sides of the cat litter bin. Central holes corresponding to the central shafts are defined on two sides of the base. The central shafts are one-to-one disposed in the central holes. The limiting structures are configured to limit a rotation stroke of the cat litter bin on the base, so that an anti-pinch space is defined between the cat litter bin and the base in a rotation direction of the cat litter bin. The anti-pinch structure effectively prevents a cat from being pinched.

### TECHNICAL FIELD

The present disclosure relates to a field of pet supplies, and in particular to a cat litter box and an anti-pinch structure thereof.

### BACKGROUND

Cat litter boxes are a relatively new product that has emerged in recent years. The cat litter boxes are configured to store cat litter in a cat litter bin thereof for cats to use for urination and defecation. In particular, automatic cat litter boxes with automatic cleaning functions allow a cat litter bin thereof to swing back and forth in opposite directions on a base thereof to automatically clean up cat feces. However, in the automatic cat litter boxes, when the driving mechanism thereof malfunctions, preventing the cat litter bin from swinging properly, a cat may be pinched between the cat litter bin and the base, resulting in injury or even death of the cat. Clearly, conventional cat litter boxes pose certain safety hazards.

### SUMMARY

To solve defects in the prior art, the present disclosure provides a cat litter box and an anti-pinch structure thereof.

The anti-pinch structure comprises a base, a cat litter bin, and limiting structures. Central shafts are disposed on two sides of the cat litter bin. Central holes corresponding to the central shafts are defined on two sides of the base. The central shafts are one-to-one disposed in the central holes. The limiting structures are configured to limit a rotation stroke of the cat litter bin on the base, so that an anti-pinch space is defined between the cat litter bin and the base in a rotation direction of the cat litter bin.

Each of the limiting structures comprises a first stopper and a second stopper. Each first stopper is disposed on a corresponding one of the central shafts. Each second stopper is disposed on a corresponding one of the central holes. Each first stopper and a corresponding second stopper are located on a same rotation circumference, so that each second stopper is configured to stop the first stopper of a corresponding one of the central shafts in the rotation direction of the cat litter bin to define a rotation stroke of the each of the central shafts.

Each second stopper comprises a forward stop edge and a reverse stop edge. When the cat litter bin is rotated forward to enable each first stopper to abut against a corresponding forward stop edge, the anti-pinch space is defined between the cat litter bin and the base in a forward rotation direction of the cat litter bin. When the cat litter bin is rotated reversely to enable each first stopper to abut against a corresponding reverse stop edge, the anti-pinch space is defined between the cat litter bin and the base in a reverse rotation direction of the cat litter bin.

Each forward stop edge defines a forward limiting groove. When each first stopper abuts against the corresponding forward stop edge, each first stopper is placed in a corresponding forward limiting groove. Each reverse stop edge defines a reverse limiting groove. When each first stopper abuts against the corresponding reverse stop edge, each first stopper is placed in a corresponding reverse limiting groove.

Each of the central holes comprises an upper half portion and a lower half portion, and each second stop edge is disposed on the lower half portion of a corresponding one of the central holes.

Each first stopper is disposed on an outer side of the corresponding one of the central shafts, and each second stopper is disposed on an outer side of the corresponding one of the central holes.

Each first stopper is integrally formed with the corresponding one of the central shafts, and each second stopper is integrally formed with a sidewall of the corresponding one of the central holes.

Each first stopper is arc-shaped, and each second stopper is arc-shaped.

Recesses are defined on an inner wall of each of the central holes. The recesses are configured to reduce a friction force between each of the central shafts and the corresponding one of the central holes.

The present disclosure further provides a cat litter box. The cat litter box comprises the anti-pinch structure described above.

With above structural configurations, when in use, the central shafts of the cat litter bin are respectively placed in the central holes of the base, so that the cat litter bin is rotatable on the base. Moreover, by providing the limiting structures, the rotation stroke of the cat litter bin on the base is limited, so that the anti-pinch space is defined between the cat litter bin and the base in the rotation direction of the cat litter bin. In particular, when the driving mechanism of the cat litter bin malfunctions, arrangements of the limiting structures are particularly important, which effectively prevent a cat from being pinched, thereby eliminating potential safety hazard of the cat litter box.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

The present disclosure is further described below with reference to the accompanying drawings and embodiments.

FIG. 1 is a schematic diagram of an anti-pinch structure according to one embodiment of the present disclosure.

FIG. 2 is an exploded schematic diagram of the anti-pinch structure according to one embodiment of the present disclosure.

FIG. 3 is an enlarged schematic diagram of portion A shown in FIG. 2.

FIG. 4 is a schematic diagram of the anti-pinch structure according to one embodiment of the present disclosure, where an upper cover is removed.

FIG. 5 is an enlarged schematic diagram of portion B shown in FIG. 4.

FIG. 6 is a schematic diagram of the anti-pinch structure according to one embodiment of the present disclosure, where the cat litter bin is forwardly rotated to enable each first stopper being abutted against a corresponding forward stop edge.

FIG. 7 is a schematic diagram of the anti-pinch structure according to one embodiment of the present disclosure, where the cat litter bin is reversely rotated to enable each first stopper being abutted against a corresponding reverse stop edge.

FIG. 8 is a schematic diagram of the anti-pinch structure according to one embodiment of the present disclosure, where the cat litter bin is forwardly rotated to enable each first stopper being abutted against the corresponding forward stop edge, and each second stopper is in an alternate configuration.

FIG. 9 is an enlarged schematic diagram of portion C shown in FIG. 8.

FIG. 10 is a schematic diagram of the anti-pinch structure according to one embodiment of the present disclosure, where the cat litter bin is reversely rotated to enable each first stopper being abutted against the corresponding reverse stop edge and each second stopper is in another alternate configuration.

FIG. 11 is an enlarged schematic diagram of portion D shown in FIG. 10.

### DETAILED DESCRIPTION

### Embodiment 1

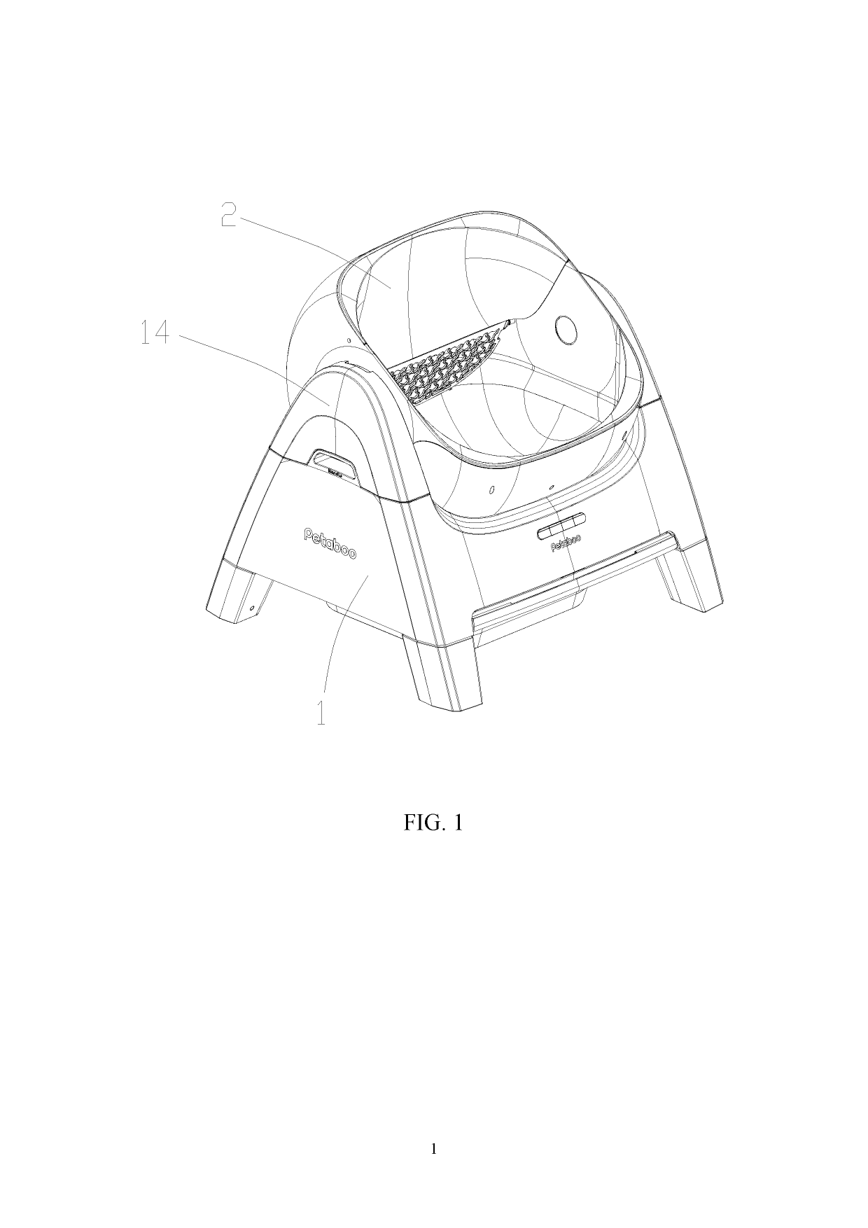

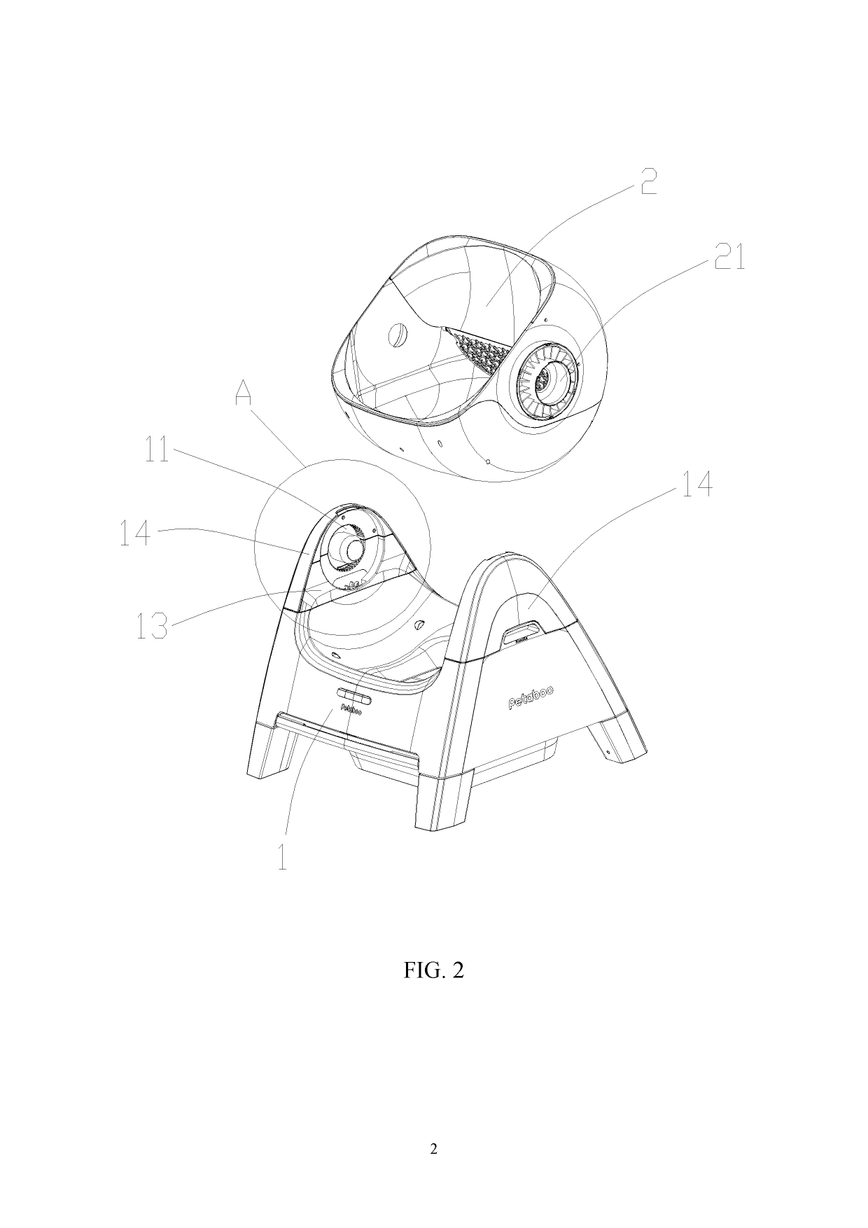

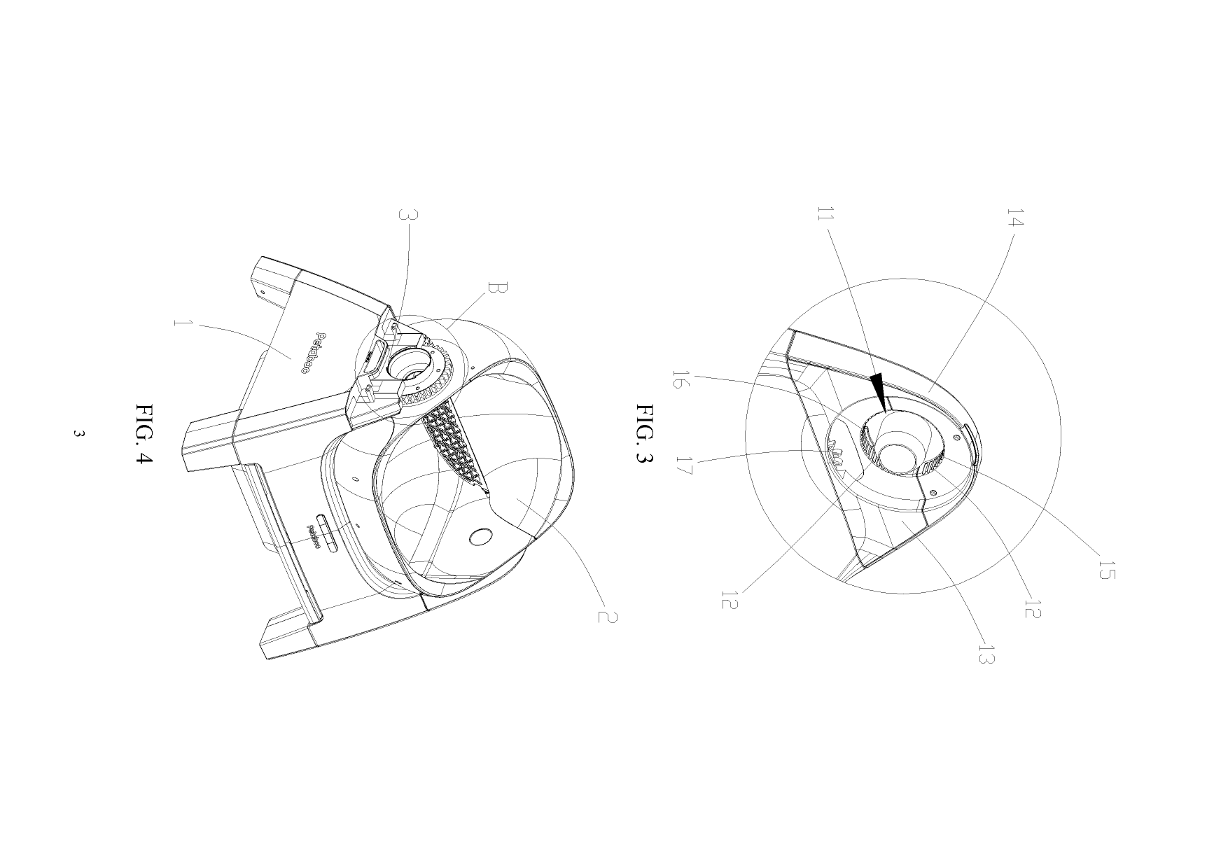

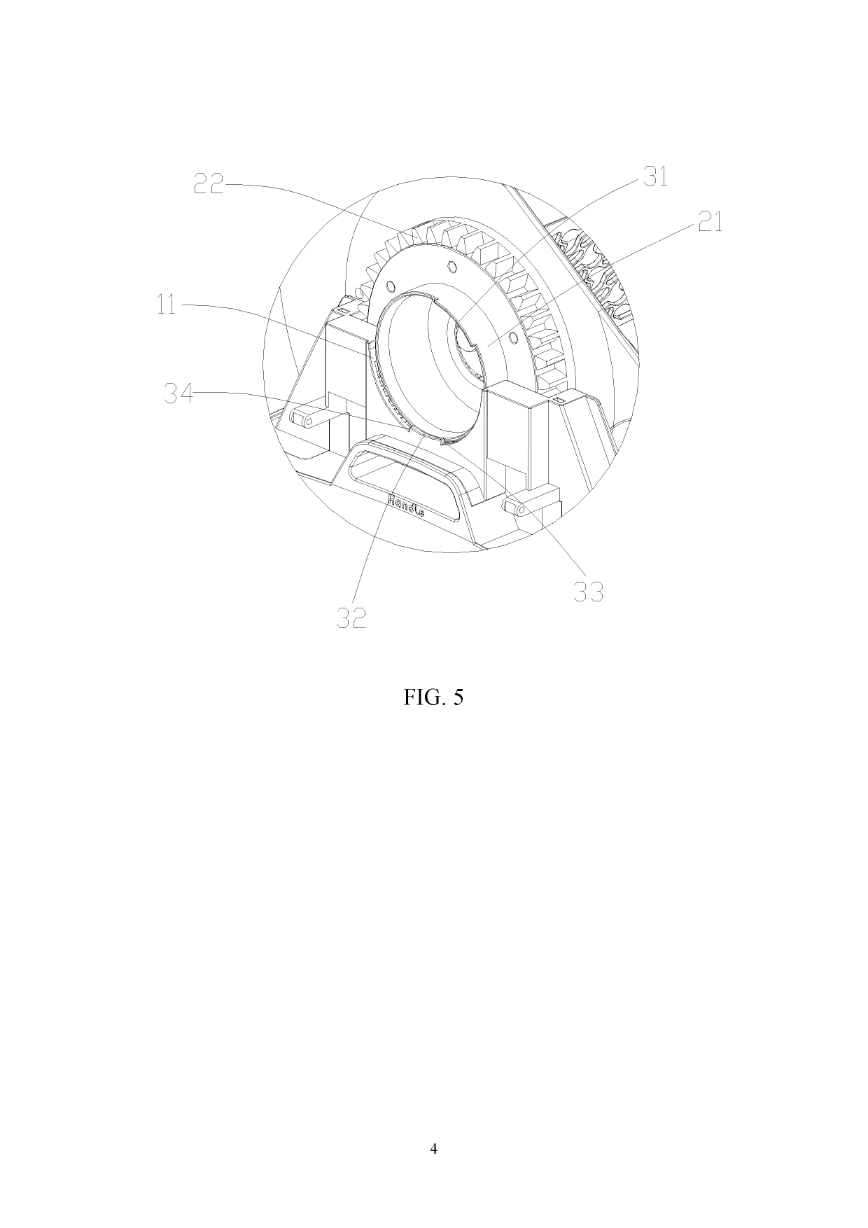

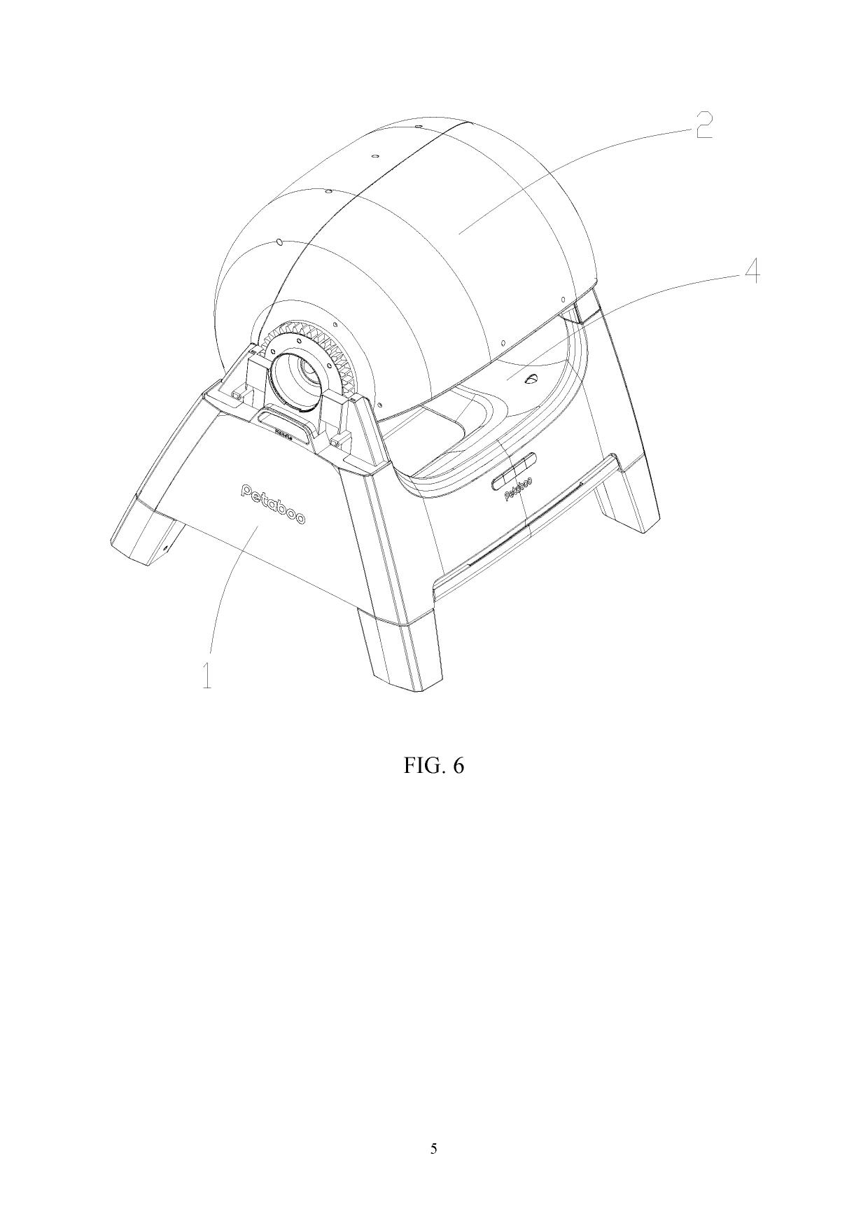

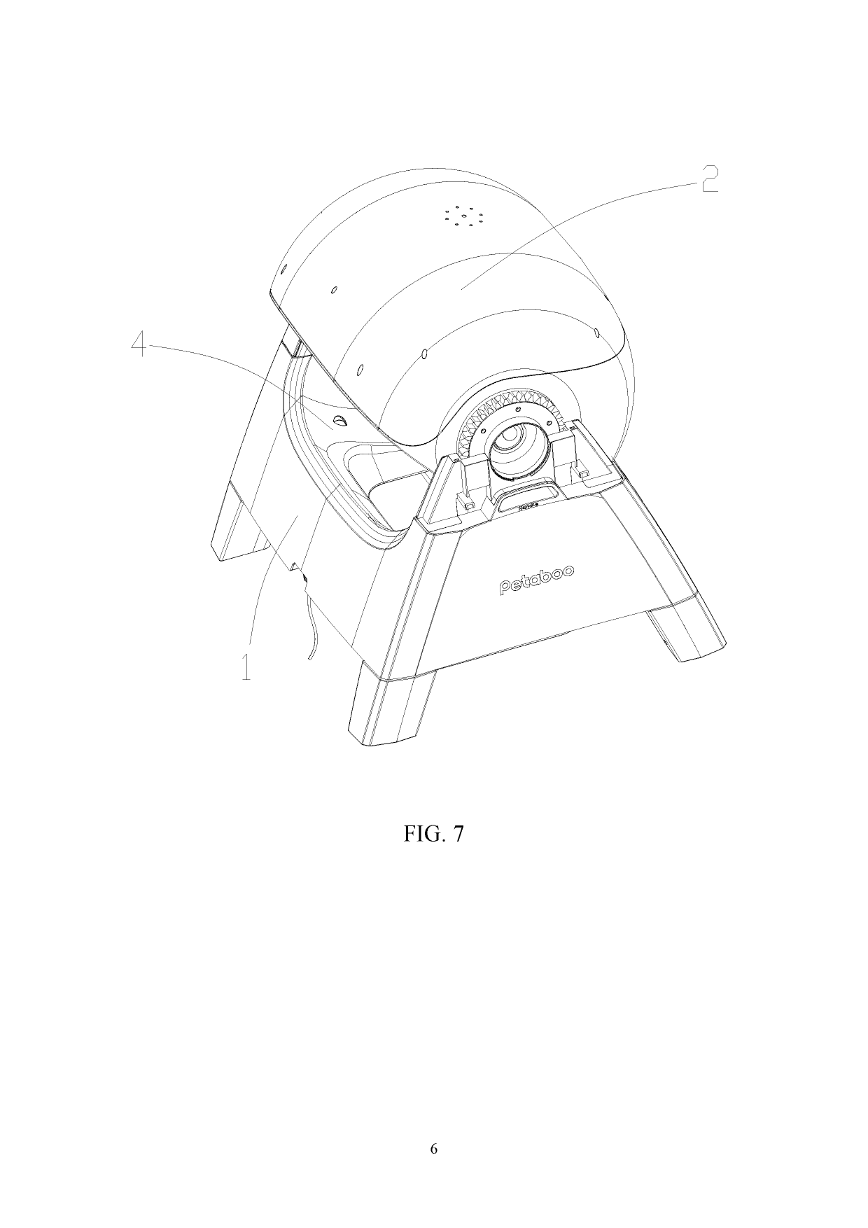

As shown in FIGS. 1-7, the present disclosure provides an anti-pinch structure of a cat litter box. The anti-pinch structure comprises a base 1, a cat litter bin 2, and limiting structures 3. Central shafts 21 are disposed on two sides of the cat litter bin 2. Central holes 11 corresponding to the central shafts 21 are defined on two sides of the base 1. The central shafts 21 are one-to-one disposed in the central holes 11. The limiting structures 3 are configured to limit a rotation stroke of the cat litter bin 2 on the base 1, so that an anti-pinch space 4 is defined between the cat litter bin 2 and the base 1 in a rotation direction of the cat litter bin 2.

The base comprises lower seats 13 and upper covers 14. Each of the lower seats 13 comprises a lower half portion 16 of a corresponding one of the central holes. Each of the upper covers 14 comprises an upper half portion 15 of a corresponding one of the central holes. Each of the upper covers 14 is connected to a corresponding one of the lower seats 13 to form the corresponding one of the central holes. Each of the upper covers 14 is rotatable to open relative to the corresponding one of the lower seats 13. A driving mechanism (the driving mechanism may be a motor and not shown in the figures) is disposed inside the base. A driving gear 17 is disposed on an output end of the driving mechanism. Correspondingly, a driven gear 22 engaged with the driving gear is disposed on one of the central shafts. The driving gear 17 is configured to drive the driven gear to rotate. That is, the driving mechanism is configured to drive the cat litter bin to rotate.

With the above structural configurations, when in use, the central shafts 21 of the cat litter bin 2 are respectively placed in the central holes 11 of the base 1, so that the cat litter bin 2 is rotatable on the base 1. Moreover, by providing the limiting structures 3, the rotation stroke of the cat litter bin 2 on the base 1 is limited, so that the anti-pinch space 4 is defined between the cat litter bin 2 and the base 1 in the rotation direction of the cat litter bin 2. In particular, when the driving mechanism of the cat litter bin 2 malfunctions, arrangements of the limiting structures 3 are particularly important, which effectively prevent a cat from being pinched, thereby eliminating potential safety hazard of the cat litter box.

Each of the limiting structures 3 comprises a first stopper 31 and a second stopper 32. Each first stopper 31 is disposed on a corresponding one of the central shafts 21. Each second stopper 32 is disposed on a corresponding one of the central holes 11. Each first stopper 31 and a corresponding second stopper 32 are located on a same rotation circumference, so that each second stopper 32 is configured to stop the first stopper 31 of the corresponding one of the central shafts 21 in the rotation direction of the cat litter bin 2 to define a rotation stroke of the each of the central shafts 21. Specifically, each second stopper 32 is disposed on the lower half portion 16 of the corresponding one of the central holes 11.

Specifically, each second stopper 32 comprises a forward stop edge 33 and a reverse stop edge 34. When the cat litter bin 2 is rotated forward to enable each first stopper 31 to abut against a corresponding forward stop edge 33, the anti-pinch space 4 is defined between the cat litter bin 2 and the base 1 in a forward rotation direction of the cat litter bin 2. When the cat litter bin 2 is rotated reversely to enable each first stopper 31 to abut against a corresponding reverse stop edge 34, the anti-pinch space 4 is defined between the cat litter bin 2 and the base 1 in a reverse rotation direction of the cat litter bin 2. With the above structural configurations, even in an event where the driving mechanism malfunctions, a maximum rotational stroke of the cat litter bin is between the forward stop edge and the reverse stop edge of each second stopper, which ensures that the anti-pinch space is defined during both a forward rotation process and a reverse rotation process of the cat litter bin 2, preventing the cat from being pinched. A width of the anti-pinch space is at least sufficient enough to accommodate the cat, ensuring that the cat will not be pinched and injured.

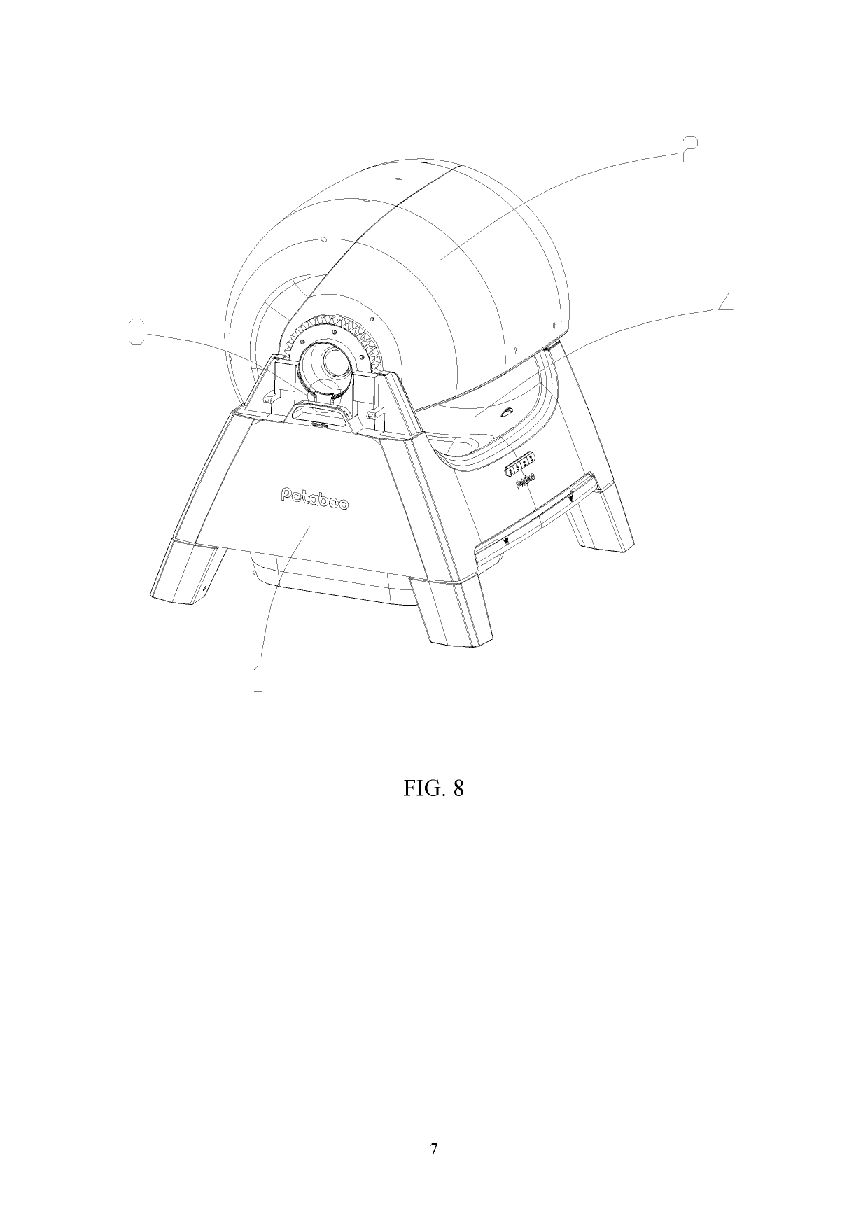

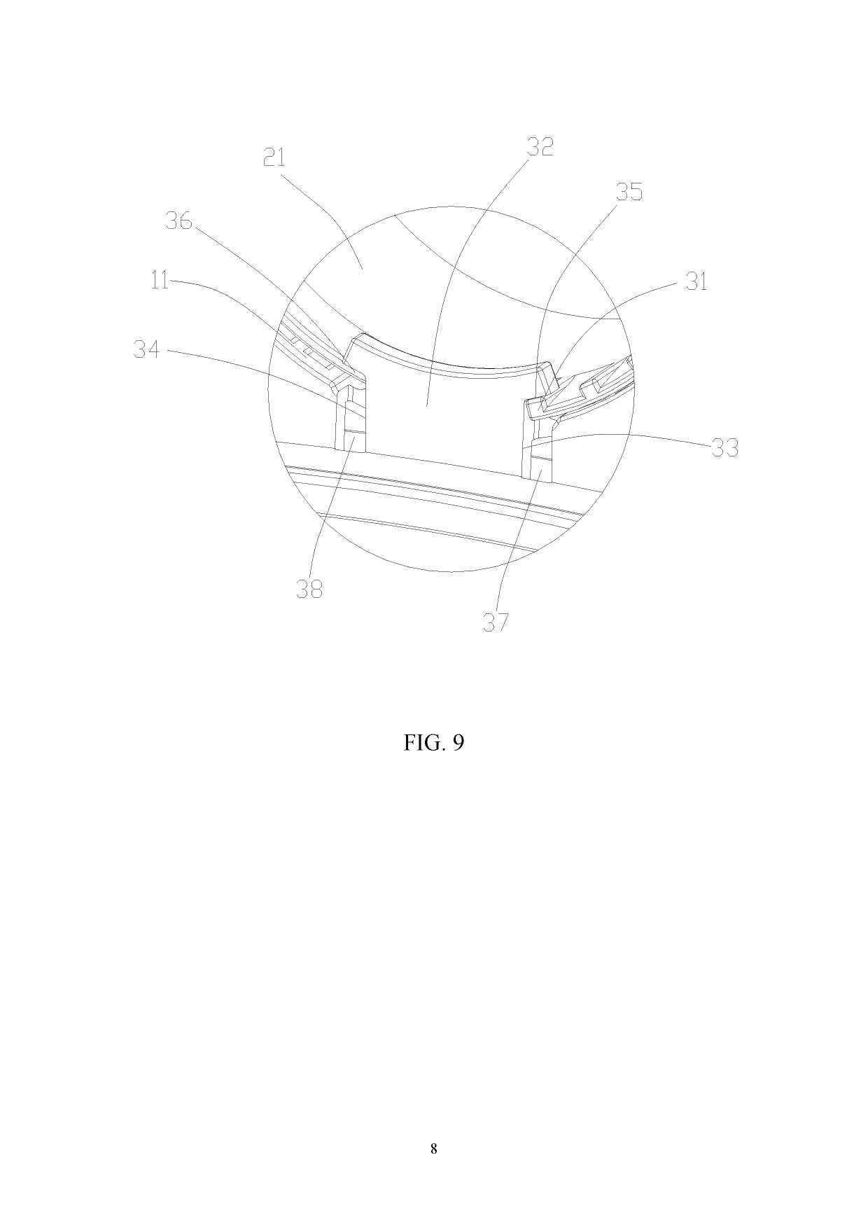

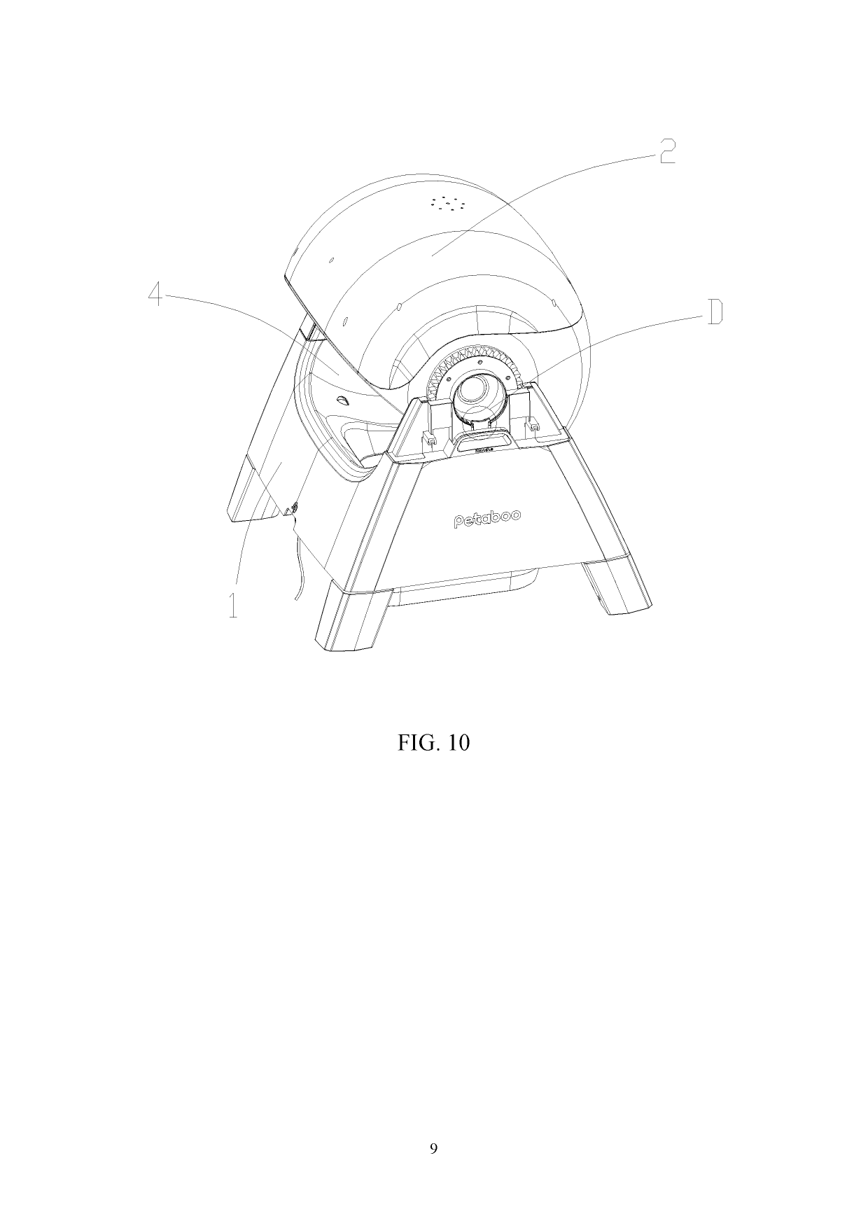

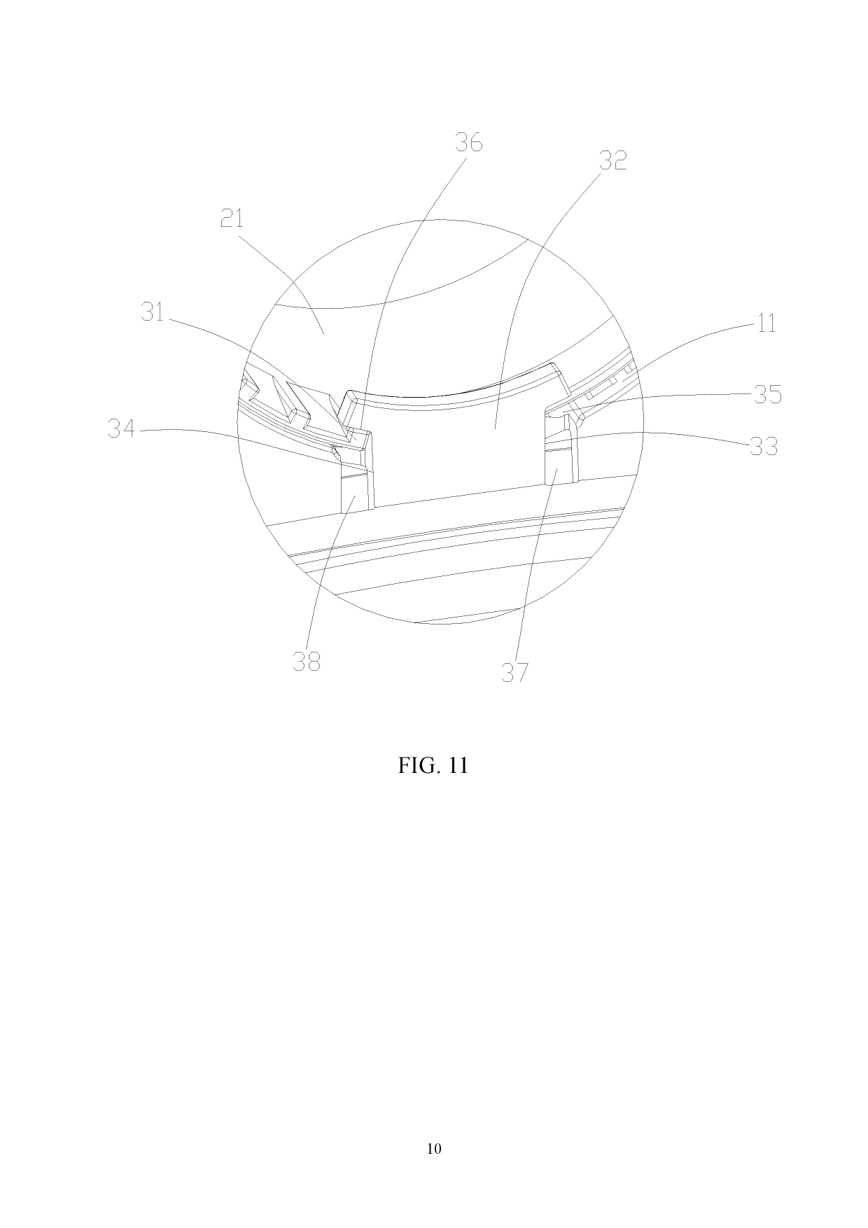

FIGS. 8-11 shows an alternative configuration of each second stopper. Each forward stop edge 33 defines a forward limiting groove 35. When each first stopper 31 abuts against the corresponding forward stop edge 33, each first stopper 31 is placed in a corresponding forward limiting groove 35. Each reverse stop edge 34 defines a reverse limiting groove 36. When each first stopper 31 abuts against the corresponding reverse stop edge 34, each first stopper 31 is placed in a corresponding reverse limiting groove 36. Specifically, each second stopper 32 is disposed on the lower half portion 16 of the corresponding one of the central holes 11.

In the embodiment, when the driving mechanism of the anti-pinch structure malfunctions, the cat litter bin rotates until each first stopper abuts against the corresponding forward stop edge, or until each first stopper abuts against the corresponding reverse stop edge. At this point, the driving gear of the driving mechanism exerts an upward force on the one of the central shafts, causing the upper half portion of a corresponding one of the central holes (a corresponding one of the upper covers) to bear a significant force. Furthermore, since each of the upper overs is rotatable to open, each of the upper overs is not suitable to withstand such a significant force. Therefore, by providing the forward limiting groove on each forward stop edge and the reverse limiting groove on each reverse stop edge, the forward limiting groove and the reverse limiting groove withstand the significant force to a certain extent. That is, each of the lower seats (i.e., the base) is able to withstand the force, making an overall structure more balanced and the anti-pinch structure more reliable and stable.

Furthermore, a forward stop portion 37 is disposed on a bottom portion of each forward limiting groove, and a reverse stop portion 38 is disposed on a bottom portion of each reverse limiting groove, so that each first stopper is able to be inserted into the corresponding forward limiting groove or the corresponding reverse limiting groove. Each second stopper has a simple structure and a reasonable design.

In the embodiment, each second stopper 32 is arc-shaped, and each second stopper 32 is integrally formed with a sidewall of the corresponding one of the central holes 11. Each second stopper has a simple structure, which is beneficial for a structural layout of the anti-pinch structure.

In the embodiment, each first stopper 31 is arc-shaped, and each first stopper 31 is integrally formed with the corresponding one of the central shafts 21. Each first stopper has a simple structure, which is beneficial for the structural layout of the anti-pinch structure.

In the embodiment, each first stopper 31 is disposed on an outer side of the corresponding one of the central shafts 21, and each second stopper 32 is disposed on an outer side of the corresponding one of the central holes 11. Each first stopper and each second stopper have simple structures, which are beneficial for the structural layout of the anti-pinch structure.

In the embodiment, recesses 12 are defined on an inner wall of each of the central holes 11. The recesses 12 are configured to reduce a friction force between each of the central shafts 21 and the corresponding one of the central holes 11. Specifically, the recesses 12 reduce a contact area between each of the central shafts and the corresponding one of the central holes, thereby reducing the friction force.

### Embodiment 2

As shown in FIGS. 1-7, the present disclosure further provides a cat litter box. The cat litter box comprises the anti-pinch structure described above.

Because the cat litter box comprises the anti-pinch structure, with the above structural configurations, when in use, the central shafts 21 of the cat litter bin 2 are respectively placed in the central holes 11 of the base 1, so that the cat litter bin 2 is rotatable on the base 1. Moreover, by providing the limiting structures 3, the rotation stroke of the cat litter bin 2 on the base 1 is limited, so that the anti-pinch space 4 is defined between the cat litter bin 2 and the base 1 in the rotation direction of the cat litter bin 2. In particular, when the driving mechanism of the cat litter bin 2 malfunctions, arrangements of the limiting structures 3 are particularly important, which effectively prevent a cat from being pinched, thereby eliminating potential safety hazard of the cat litter box.

The above content is a further detailed description of the present disclosure in combination with specific optional implementation methods, and it cannot be determined that the specific implementation of the present disclosure is limited to these descriptions. For those skilled in the art, several simple deductions or substitutions can be made without departing from the concept of the present disclosure, which should be regarded as falling within the protection scope of the present disclosure.

What is claimed is:

1. An anti-pinch structure of a cat litter box, comprising:
a base;
a cat litter bin; and
limiting structures;
wherein central shafts are disposed on two sides of the cat litter bin, central holes corresponding to the central shafts are defined on two sides of the base, and the central shafts are one-to-one disposed in the central holes;
wherein the limiting structures are configured to limit a rotation stroke of the cat litter bin on the base, so that an anti-pinch space is defined between the cat litter bin and the base in a rotation direction of the cat litter bin.

2. The anti-pinch structure according to claim 1, wherein each of the limiting structures comprises a first stopper and a second stopper, each first stopper is disposed on a corresponding one of the central shafts, each second stopper is disposed on a corresponding one of the central holes, and each first stopper and a corresponding second stopper are located on a same rotation circumference, so that each second stopper is configured to stop the first stopper of a corresponding one of the central shafts in the rotation direction of the cat litter bin to define a rotation stroke of the each of the central shafts.

3. The anti-pinch structure according to claim 2, wherein each second stopper comprises a forward stop edge and a reverse stop edge;
wherein when the cat litter bin is rotated forward to enable each first stopper to abut against a corresponding forward stop edge, the anti-pinch space is defined between the cat litter bin and the base in a forward rotation direction of the cat litter bin;
wherein when the cat litter bin is rotated reversely to enable each first stopper to abut against a corresponding reverse stop edge, the anti-pinch space is defined between the cat litter bin and the base in a reverse rotation direction of the cat litter bin.

4. The anti-pinch structure according to claim 3, wherein each forward stop edge defines a forward limiting groove, and when each first stopper abuts against the corresponding forward stop edge, each first stopper is placed in a corresponding forward limiting groove;
wherein each reverse stop edge defines a reverse limiting groove, and when each first stopper abuts against the corresponding reverse stop edge, each first stopper is placed in a corresponding reverse limiting groove.

5. The anti-pinch structure according to claim 4, wherein each of the central holes comprises an upper half portion and a lower half portion, and each second stop edge is disposed on the lower half portion of a corresponding one of the central holes.

6. The anti-pinch structure according to claim 2, wherein each first stopper is disposed on an outer side of the corresponding one of the central shafts, and each second stopper is disposed on an outer side of the corresponding one of the central holes.

7. The anti-pinch structure according to claim 5, wherein each first stopper is integrally formed with the corresponding one of the central shafts, and each second stopper is integrally formed with a sidewall of the corresponding one of the central holes.

8. The anti-pinch structure according to claim 2, wherein each first stopper is arc-shaped, and each second stopper is arc-shaped.

9. The anti-pinch structure according to claim 1, wherein recesses are defined on an inner wall of each of the central holes, and the recesses are configured to reduce a friction force between each of the central shafts and the corresponding one of the central holes.

10. A cat litter box, comprising: the anti-pinch structure according to claim 1.
